(19) United States
(12) Patent Application Publication
(10) Pub. No.: US 2017/0122121 A1
(43) Pub. Date: May 4, 2017

(54) HYBRID ELECTRICAL RENEWABLE ENERGY SOURCE

(71) Applicants: Brian Rosser Rejniak, Yorba Linda, CA (US); John Alan Rejniak, Corona, CA (US)

(72) Inventors: Brian Rosser Rejniak, Yorba Linda, CA (US); John Alan Rejniak, Corona, CA (US)

(21) Appl. No.: 15/339,851

(22) Filed: Oct. 31, 2016

Related U.S. Application Data
(60) Provisional application No. 62/249,109, filed on Oct. 30, 2015.
(60) Provisional application No. 62/277,822, filed on Jan. 12, 2016.

(51) Int. Cl. F01D 15/10; E04H 4/12; F01D 17/10; F01D 21/00; F01D 5/02; F01D 15/08

(52) U.S. Cl. CPC F01D 15/10; F01D 5/02; F01D 15/08; F01D 17/105; F01D 21/003; E04H 4/1245; F05D 2210/11; F05D 2240/60

(57) ABSTRACT

A system having a motor coupled to and powering a pump for pumping a liquid, the motor being configured to start by receiving electric power from a power source, a turbine mounted in line with the pump within a conduit where flow of the liquid causes rotation of the turbine, the turbine being associated with a generator, and, an automatic transfer switch configured to monitor a power output of the generator and, when the power output is sufficient for the motor to run, to provide the power output to the motor and to disconnect the power source from the motor.

### CROSS-REFERENCE TO RELATED APPLICATIONS

This application claims the benefit of U.S. Provisional Application No. 62/249,109, filed Oct. 30, 2015 and U.S. Provisional Application No. 62/277,822, filed Jan. 12, 2016, which are hereby incorporated by reference, to the extent that they are not conflicting with the present application.

### BACKGROUND OF THE INVENTION

1. Field of the Invention

The invention relates generally to swimming pool pump motors and more specifically to a system and method for saving energy when running swimming pool pump motors.

2. Description of the Related Art

One of the largest expenses for pool owners is the cost of electricity to run their swimming pool equipment. Swimming pool equipment consuming electricity is primarily electrically powered pool pumps. Pool pumps typically consumes expensive off the grid line power, also known as utility power to the home or commercial establishment. The pool pumps need to run typically several hours a day to maintain the pool water clean and prevent the growth of algae and bacteria. That can be very expensive. Thus, there is a need for a new system and method for energy saving that can be used when running pool pumps.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In one exemplary embodiment, a generator pump/turbine is mounted in-line with and downstream of a pool pump in a swimming pool system. The turbine is coupled with a generator that can generate electricity. An automatic transfer switch is also provided to switch the power source for the pool pump motor from the utility power line to the generator when the generator can supply adequate power. Thus, an advantage is that energy is saved when running a pool pump, which can significantly decrease the utility bill of a pool owner.

In another exemplary embodiment the flow of water through the main water line is regulated by a flow control module using a bi-directional flow regulator and a bypass line separate from the main water line. Thus, an advantage is that, by automatically diverting some water flow from the main water line into the bypass line when necessary, the speed of the generator can be stabilized, to prevent for example an over speed condition.

The above embodiments and advantages, as well as other embodiments and advantages, will become apparent from the ensuing description and accompanying drawings.

### BRIEF DESCRIPTION OF THE DRAWINGS

For exemplification purposes, and not for limitation purposes, embodiments of the invention are illustrated in the figures of the accompanying drawings, in which:

FIG. 1 is a diagram depicting conceptually a hybrid electrical renewable energy source system (“H.E.R.E.S. system” or “energy system”) in a first state, according to an embodiment.

FIG. 2 illustrates the energy system from FIG. 1 in a second state.

FIG. 3 is a simplified wiring diagram for the energy system from FIG. 1, according to an embodiment.

FIG. 4 is a schematic view of an energy system, according to an embodiment.

FIG. 5 is a perspective view of an example of an energy system, according to an embodiment.

FIG. 6 is a top view of an example of an energy system in a typical installation configuration, according to an embodiment.

FIG. 7 is a side and cutaway view of an example of inline turbine, which can be used in the energy system from FIG. 5.

FIG. 8 is an open side view of an example of generator unit, which can be used in the energy system from FIG. 5.

FIG. 9 is a top view of an example of control panel, which can be used in connection with the energy system from FIG. 5.

FIG. 10 depicts conceptually an example of panel layout, which can be used in connection with the energy system from FIG. 5.

FIGS. 11a-11b illustrate a top view and a side view, respectively, of a flow control manifold having a flow control module, a main line and a bypass line, for use with a hybrid electrical renewable energy source system, according to an embodiment.

FIG. 12 illustrates the flow control manifold of FIGS. 1a-1b as an example of installation into a plumbing application, according to an embodiment.

FIG. 13 illustrates a top view of the main line, the inline turbine/impeller in an open state and pool equipment pipe unions on each end of the main line, and a portion of the bypass line, according to an embodiment.

FIGS. 14a-14b illustrate a top view and a side view, respectively, of the inline turbine/impeller of the main line, according to an embodiment.

FIG. 15 illustrates a side view of a generator universal mount support used with the flow control manifold, according to an embodiment.

FIG. 16 is a diagram showing the control of the flow control module using a proximity switch/sensor as a detection device, according to an embodiment.

FIG. 17 is a flow chart illustrating a simplified example of a process for regulating the bi-directional valve for generator speed regulation, according to an embodiment.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

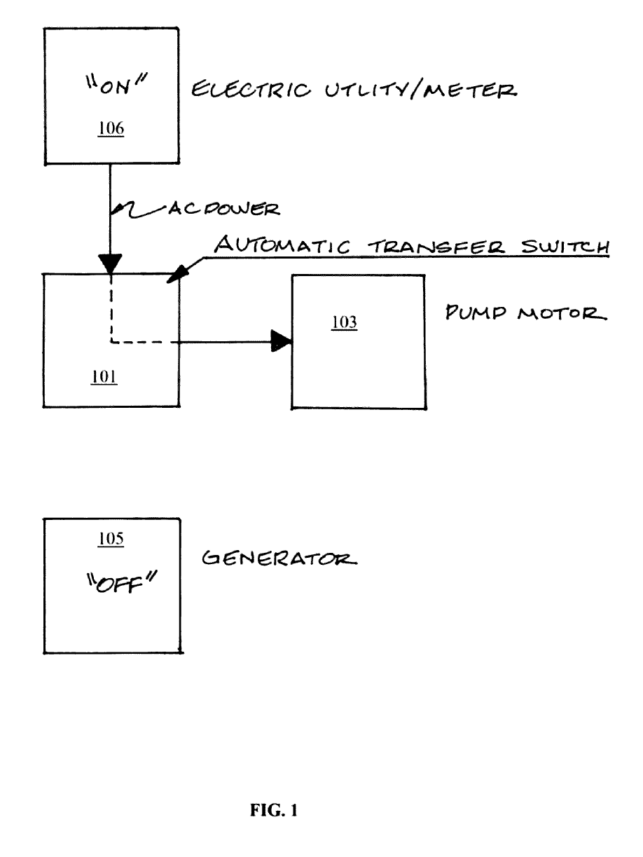

FIG. 1 is a block diagram depicting conceptually a hybrid electrical renewable energy source system (“H.E.R.E.S. system” or “energy system”) in a first state, according to an embodiment. As shown, the energy system disclosed herein may include a generator 105 and an automatic transfer switch (“ATS”) 101, which can communicate electrically with the generator 105, a pump motor 103 and a line/utility power 106. Line/utility power is the power provided by the residential or commercial utility. The block diagram in FIG. 1 gives a simplified direction of the route of line/utility power 106 during a first state of the energy system, namely the start-up of the pool pump motor 103. As shown, at start-up, the pool pump motor 103 is typically energized by line/utility power 106 routed to the motor 103 by automatic transfer switch 101. As shown, in this first state, the generator 105 is typically “off” in that it is not providing power to the pump motor 103.

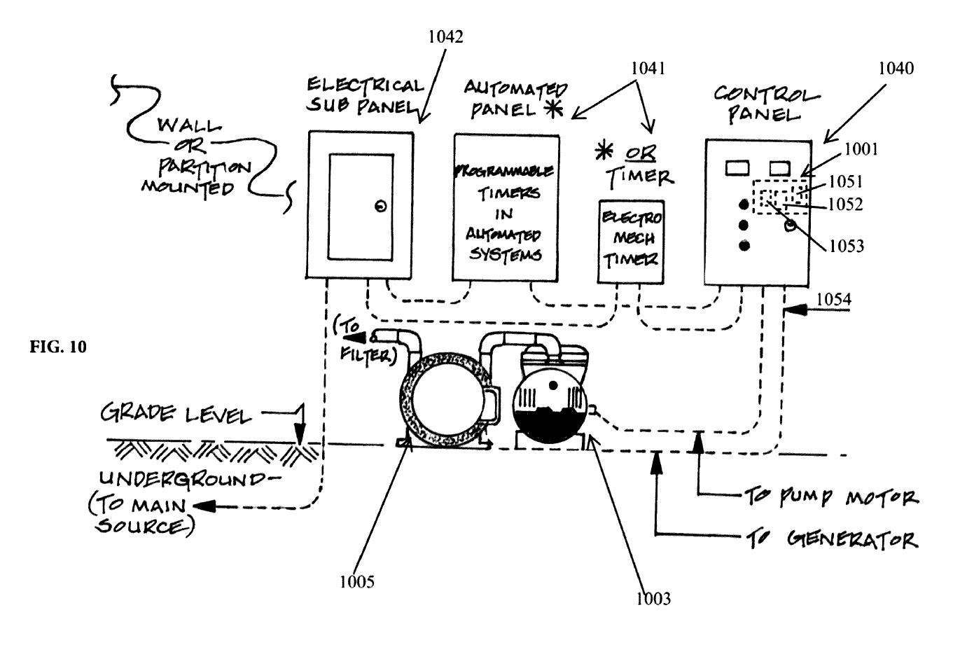

In an example, the utility 106, pump motor 103 and generator 105 can be electrically routed to an ASCO UL listed transfer switch 101, or equivalent. The automatic transfer switch 101 (1001 in FIG. 10) may be automatic, switching power from line utility power 106 to power from the generator 105 (1005 in FIG. 10), when the generator is spooled up to proper RPM and voltage output. The generator/alternator 105, 1005 then provides consistent alternate power to pump motor 103 (1003 in FIG. 10). The automatic transfer switch (ATS) 101, 1001 may have an electronic time delay. The delay may be 20-30 seconds to allow the generator/alternator 1005, synchronous type, to stabilize. The electronic time delay can be initiated by the input 1054 (FIG. 10) from generator/alternator 1005, which is monitored by the ATS 101, 1001. The ATS 101, 1001 automatically switches the generator/alternator 105, 1005 to the pump 103, 1003 after the 20-30 seconds electronic control time-out mentioned above. The ATS 101 may have an electronic control (1052 in FIG. 10) that monitors a 240 volts input 1054 from the generator/alternator 105, 1005.

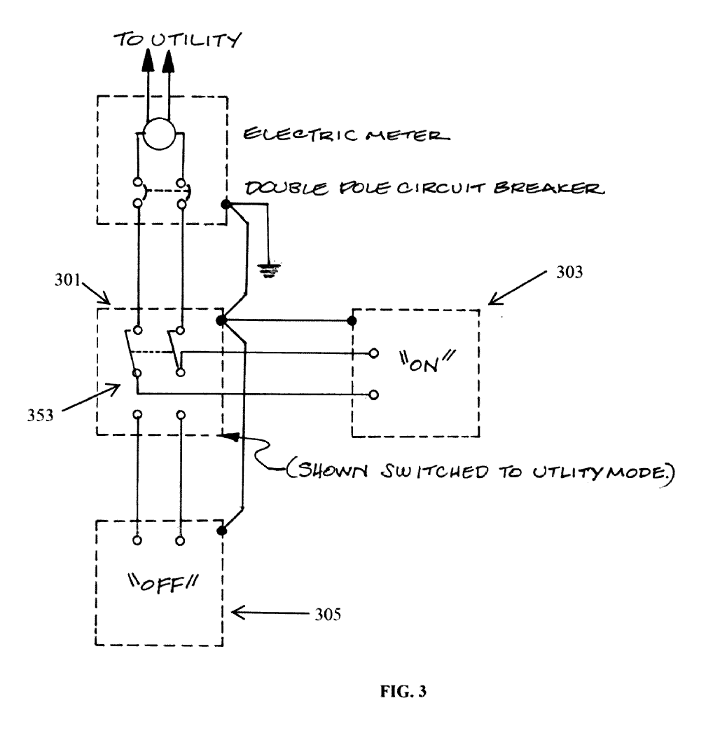

In an example, the line voltage/utility may be turned on via a timer switch (1041 in FIG. 10), and then the line voltage may be directed to a 50 amp, 250 Volt AC rated DPDT (double pole, double throw) contactor (1053 in FIG. 10; see also 353 in FIG. 3). The output (load side) is directed to the pump motor 1003 on the N.C. (normally closed side). When the electronic timing switch (1051 in FIG. 10) times out, the mechanically interlocked contactor 1053 switches, via the electronic timer switch 1051, to the N.O. (normally open) side; thus, the output (load side) is directed to the pump motor 1003.

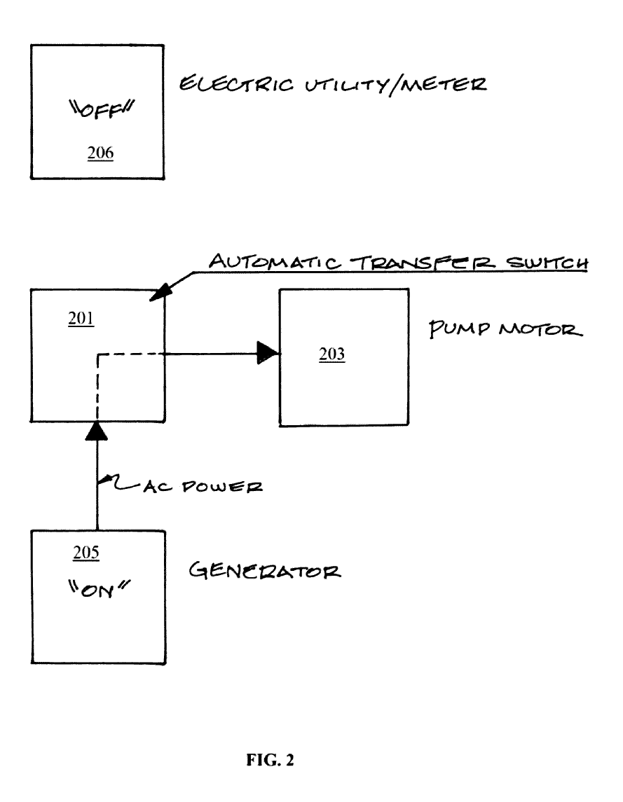

Again, in an example, as stated above, the line/utility power 106 may initially start the pool pump motor 103, 1003 then the generator 105, 1005 may supply the required power to keep the pump motor 103, 1003 running via the automatic transfer switch 101, 1001, eliminating the line/utility power 106 to source the pool pump motor 103 (see FIG. 2). Typically, the ATS 101, 1001 will maintain the generator/alternator 105, 1005 as an alternate power source until the pool timer (1041 in FIG. 10) shuts the circuit off, or, in very rare occasions, a pool water circulation malfunction.

As it will be explained and shown in more details hereinafter when referring to subsequent figures, the pump motor (103) is turning the pump causing a high volume of water to flow through the generator turbine (105) or impeller (whichever will be used to spin the generator). In an example, water flow discharge from the pump (502) is plumbed into the turbine pump (504) which causes the generator (505) to spin. The spinning turbine, or impeller (e.g., 704b) mechanically coupled to the generator (505) may now spin at high rpm producing sufficient electrical power to switch the transfer switch (101, 401), such that the generator may power the pump motor 503. Suction via the skimmer and drain (607a) flows back to the pump motor (602) pumping water to turbine/impeller (604). Water flowing to turbine or impeller pump (604) is spinning the turbine/impeller, turning the generator (605). Water flows to pool filter (611) and circulates back to the swimming pool (607b). This is a closed loop system and water is always flowing while the pump motor is on.

The electric utility source 106 may be for example a main panel, sub panel (1042 in FIG. 10), automated equipment panel, or electromechanical timer (1041 in FIG. 10). Most electric utility sources will be in place, with possibly the exception of new construction.

Again, FIG. 2 illustrates the energy system from FIG. 1 in an exemplary second state, namely when the generator 205 is “on” in that it is providing power to the pump motor 203, while the utility line 206 is “off,” meaning that it is not providing power to the pump motor 203, thus saving on the utility bill charges.

FIG. 3 is an exemplary simplified wiring diagram for the energy system from FIG. 1, according to an embodiment. This block diagram shows a simplified line routing through the automatic transfer switch 301 using a double pole switch from the utility, generator 305 and pool pump motor 303. It basically illustrates how the system may be connected, as an example.

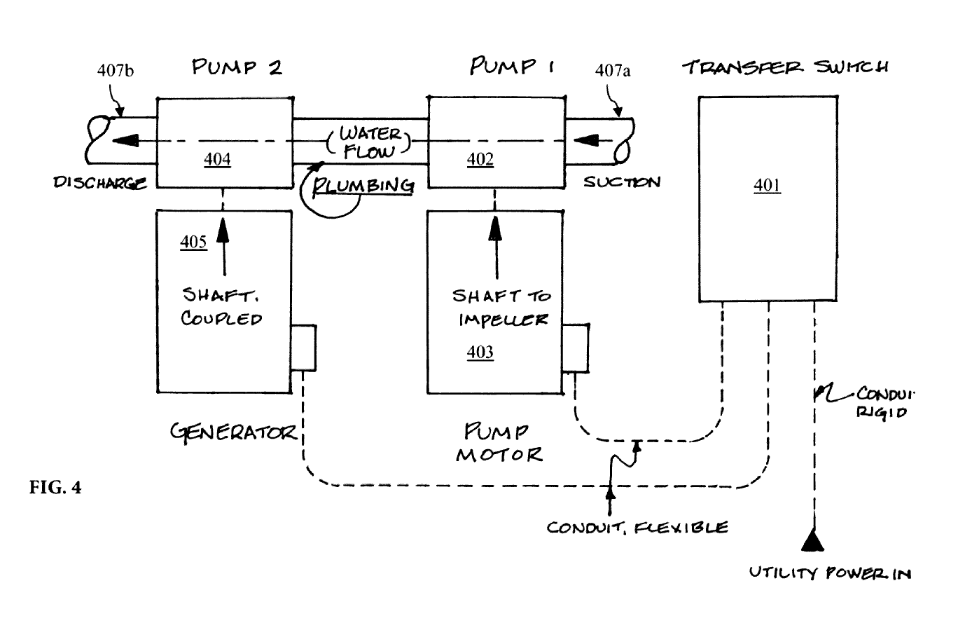

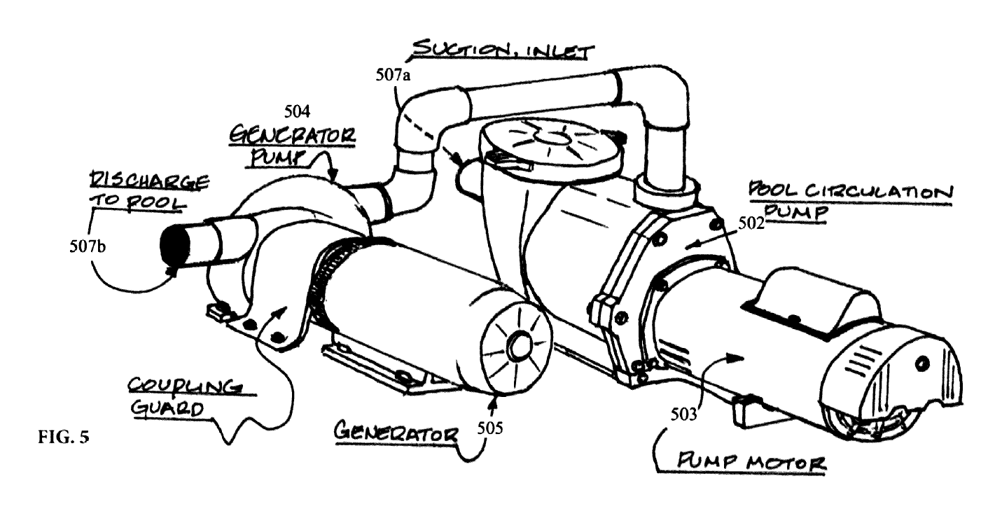

FIG. 4 is a schematic view of an energy system, according to an embodiment. FIG. 5 is a perspective view of an example of an energy system, according to an embodiment. The two figures shows that the pool pump 402/502 can power generator pump/turbine 404/504, which interconnects to the generator 405/505, which then can generate electricity that can be used in turn to power pool pump motor 403/503. To achieve this, as shown, the turbine 404/504 may be installed in-line with and preferably downstream of pool pump 402/502. Thus, after pool water is drawn through the suction pipe 407a/507a by the pool pump 402/502, the pool water is passed through turbine 404/504, causing it to spin, before the pool water returns to the pool via discharge pipe 407b/507b. In turn, because turbine 404/504 is coupled with generator 405/505, the generator 405/505 will spin as well and thus generate electricity.

The generator pump 404/504 may be a turbine or impeller type capable of no less than 3600 RPM sustained. Sealed ball bearings should preferably be used. Sealed ball bearings provide a lower drag coefficient with an expected longer life span.

It should be noted that for installation purposes, the automatic transfer switch 401 will preferably be mounted vertically. It should be further noted that FIG. 5 provides a mechanical explanation of how the components may be fitted together. It should be understood however that the pool circulation pump 502 and generator pump 504 locations most likely will vary with each installation.

The generator 505 may be an asynchronous (induction generator), or synchronous generator, or an induction motor. The generator 505 (also known as an alternator), will preferably provide AC power with nameplate voltages: 120, 208-220, 230, 240, 440, 460 and 480 Volts AC RMS, (Root Means Square voltage as opposed to peak-to-peak voltage in a sine wave as seen in an oscilloscope), single-phase, or three phase in some commercial pool pumps. The usable voltage is preferably plus or minus 10%. AC is referring to Alternating Current as opposed to DC, referring to Direct Current, which may be used as an exciter circuit in asynchronous generators.

With respect to the rating of the generator, it will preferably be no less than 125% of the pool pump load. Load is the current a motor draws or consumes at normal operation.

Output frequency of the generator may be rated at 60 Hz. Hertz is expressed as cycles per second of a sine wave. In AC, the sine wave oscillates 60 times in one second. Acceptable tolerance is plus or minus 1%.

The generator may be dedicated to the pool pump or pumps depending on each application and size of the generator. While an option, no co-generation is intended to feed other sources, equipment or back feed the grid/utility with the type of automatic transfer switch (401 in FIG. 4) disclosed herein. This is preferably a dedicated circuit for a specific purpose, namely to run the motor of a pool or spa pump.

Generators, like transformers are usually sized in kVA (kilo or thousand volt amps), less power factor, which is used in actual wattage. An example is a 5.5 kVA generator (I=1000×5.5 kVA/E, or I=22.92 amps at 240 Volts AC), which is sufficient to power a typical 240 Volts AC pump motor. “I” is current measured in Ampere (SI unit symbol: A), often shortened to “amp”, and “E” is EMF (Electromotive force) measured in Volts AC.

As described hereinbefore, power to the generator will be supplied by a hydro (water) source in the circulation plumbing of a swimming pool or spa system, via a generator pump/turbine 404/504 (coupled to the generator). The generator pump/turbine 404/504 can thus utilize a high volume of water received from the pool pump.

Pipe sizes for the generator pump may vary from 1 inch to 1½ inch or 2 inch diameter-the most commonly used. Various attachments to the generator may be used including, but not limited to, direct drive via shaft couplings, adaptive drives using a balanced flywheel or a mechanical gear box for speed (RPM-Revolutions Per Minute) increasing or reduction to ensure reductions of fluctuations in the generator speed.

In some applications, a capacitor bank may be necessary for the generator to provide stable power and RPM with the purpose in keeping the pump motor from slowing down causing the pump motor to switch back to line/utility power.

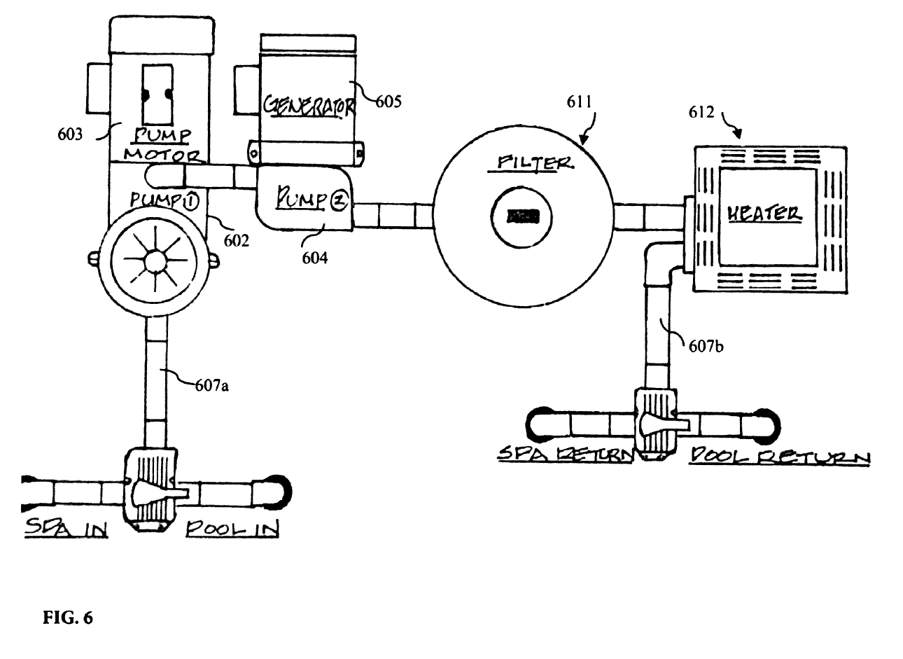

FIG. 6 is a top view of an example of an energy system in a typical installation configuration, according to an embodiment. As described hereinbefore when referring to FIGS. 4-5, after pool or spa water is drawn through the suction pipe 607a by the pool pump 602, the pool water is passed through turbine 604, causing it to spin, before the pool water returns to the pool or spa via filter 611, heater 612 and discharge pipe 607b. In turn, because turbine 604 is coupled with generator 605, the generator 605 will spin as well and thus generate electricity.

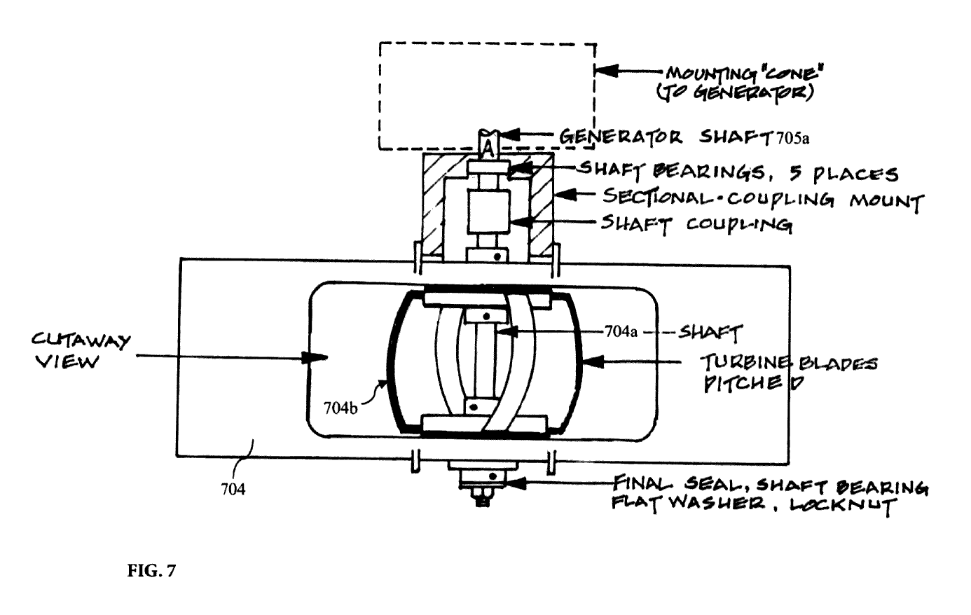

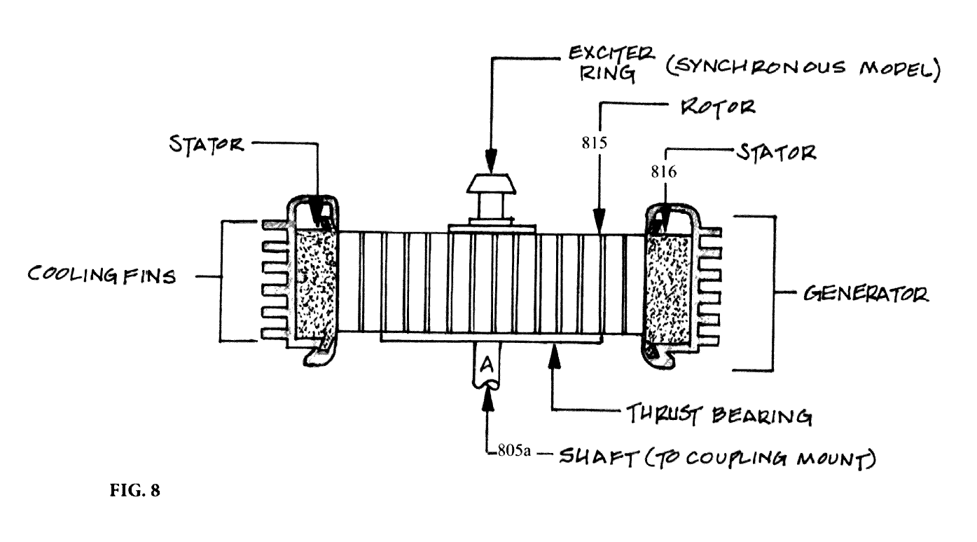

FIG. 7 is a side and cutaway view of an example of inline turbine, which can be used in the energy system from FIG. 5. FIG. 8 is an open side view of an example of generator unit, which can be used in the energy system from FIG. 5. As shown in FIG. 7, the inline turbine 704 may include a shaft 704a to which pitched blades 704b are attached such that the blades 704b can convert a portion of the kinetic energy of the moving pool water into a rotational motion of the turbine shaft 704a. The turbine shaft 704a can be coupled to the generator shaft 705a (805a in FIG. 8) so that they rotate together, causing the spin of rotor 815 mounted on generator shaft 805a inside stator 816, and thus generating electricity as known in the art.

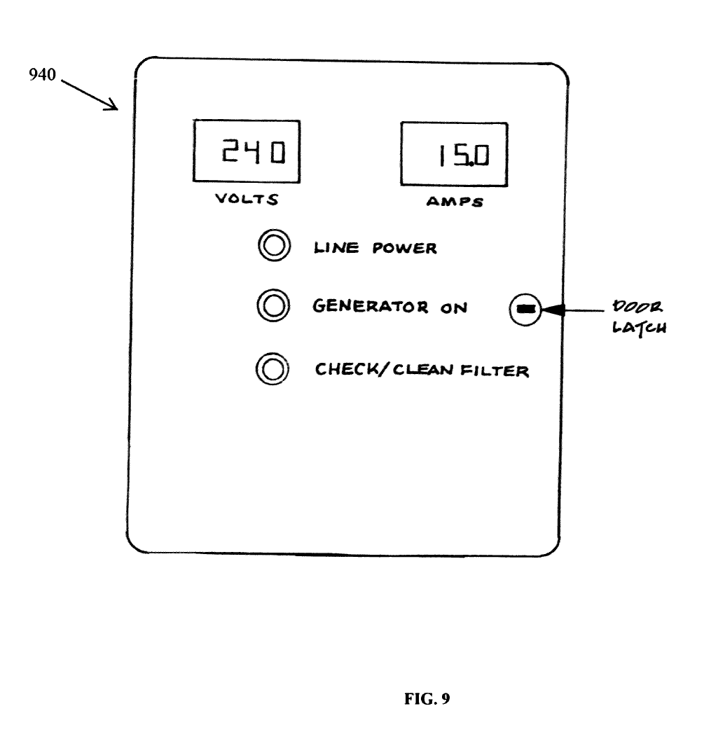

Again, FIG. 9 is a top view of an example of control panel 940, which can be used in connection with the energy system from FIGS. 1-5. FIG. 10 depicts conceptually an example of panel layout, including control panel 1040 and pool timer panel 1041, which can be used in connection with the energy system from FIGS. 1-5.

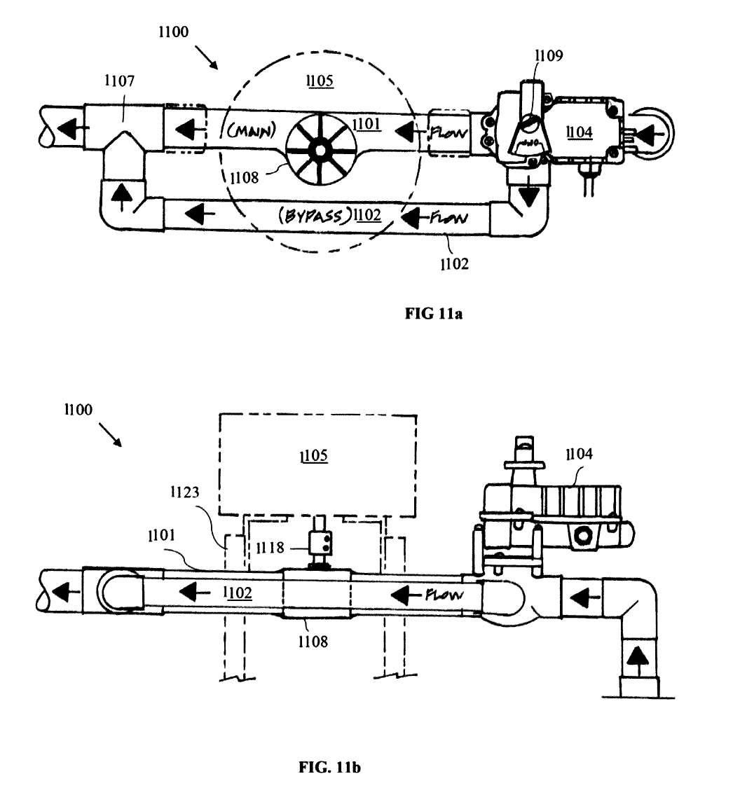

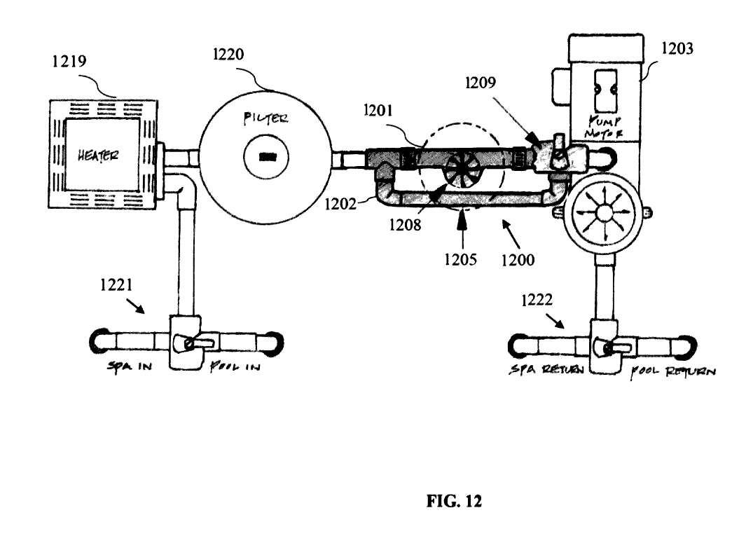

FIGS. 11a-11b illustrate a top view and a side view, respectively, of a flow control manifold 1100, having a flow control module 1104, a main line 1101 and a bypass line 1102, for use with a hybrid electrical renewable energy source system (“H.E.R.E.S. system,” “HERES,” or “energy system”), according to an embodiment. The energy system disclosed herein may include a generator 1105 and an automatic transfer switch (e.g., 101 in FIG. 1), which can communicate electrically with the generator 1105, a pump motor (1203 in FIG. 12) and a line/utility power (e.g., 106 in FIG. 1). The line/utility power is typically the power provided by the residential or commercial utility. The water flow control or regulation means described herein when referring to FIGS. 11a-17 may be used with the energy source system described herein in order for the system to function efficiently and stably by controlling the speed of the generator 1105.

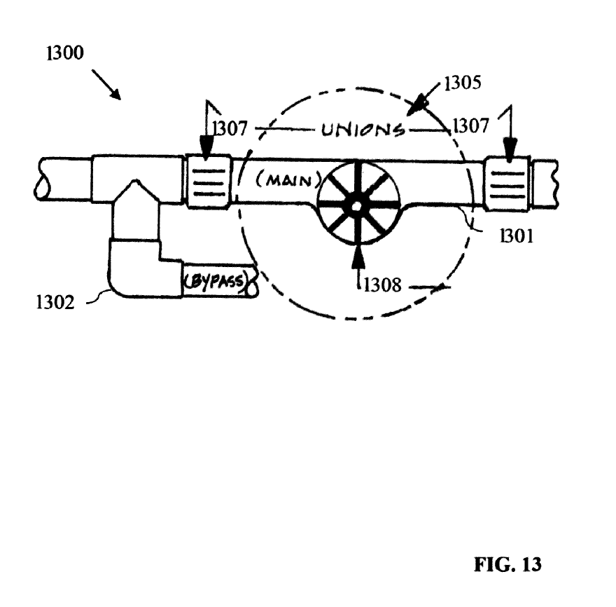

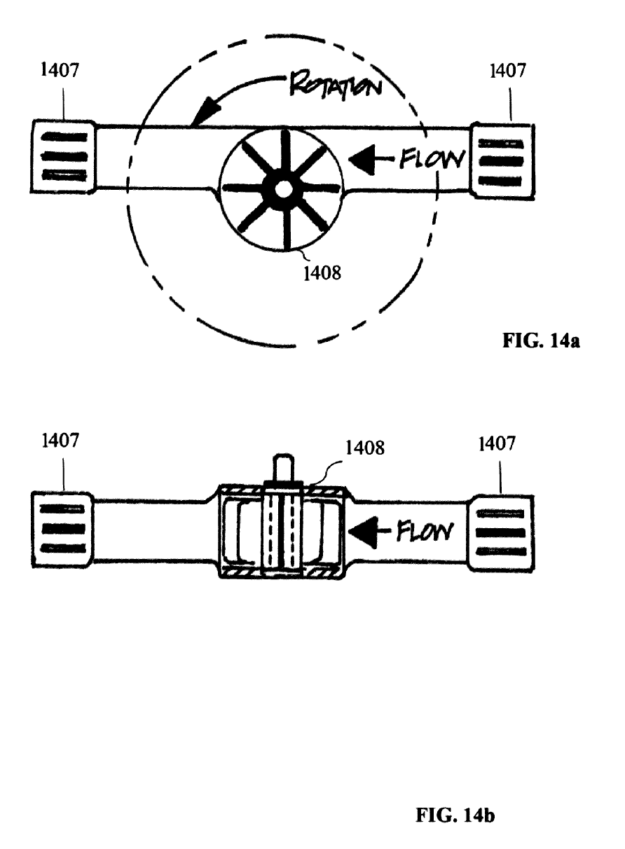

The main line 1101 of the flow control manifold 1100 may also be integrated with an inline turbine/impeller 1108. The inline turbine/impeller 1108 is shown in an open state in FIG. 11a, illustrating the inside of the component. Unions (shown in FIG. 13 and FIGS. 14a-14b) may be used for associating the inline turbine/impeller 1108 with the main line 1101. The main line 1101 and the turbine/impeller 1108 may be composed of any suitable type of water-compatible materials, such as, for example, PVC, durable plastics, brass, bronze, copper, and stainless steel. Other components such as shaft bearings, thrust washers, and seals may also be composed of any suitable material known in the art.

The bypass line 1102 and its fittings may be minimum schedule 40 or 80 PVC in all threaded fittings, and may provide an alternate route for water flow. This may allow for the bleed off of excess water flow to the turbine 1108 in the case of for example the turbine 1108 being in an over speed, excessive RPM (Revolutions Per Minute), condition. Utilizing both the main 1101 and bypass 1102 lines may ensure that the circulation system maintains the same flow rate, with no reduction in flow rate and pressure within the system, which may allow for efficient continuous running of the energy system as needed.

The flow control module 1104 may include a bi-directional flow regulator 1109, which may be a bi-directional servo, with a forward (open) and reverse (closed) position capability. FIGS. 11a-11b illustrate the bi-directional flow regulator 1109 in the fully closed position with respect to the bypass line, as indicated by the position of the bi-directional flow regulator 1109. With, for example, a 24 volt AC input, the flow control module 1104 may be pulsed to be fully open with respect to the main line 1101, or partially open, diverting water flow through the bypass line 1102, which reduces water flow through the main line 1101. The flow control module 1104 may control the water flow in order to maintain the generator 1105 RPM at a desired speed, by utilizing these two main 1101 and bypass 1102 lines. The term “line” may refer to all the flow control manifold 1100 plumbing and may be inclusive of the turbine/impeller 1108 and flow control module 1104.

A top-mounted generator 1105 and generator mount 1123 are illustrated in FIG. 11b, illustrating and example of how the flow control manifold 1100 may be fitted with a generator 1105. A shaft coupling 1118 is illustrated, showing the coupling between the generator 1105 and turbine 108. The generator 1105 is preferably suitable for outdoor use, or may be properly encased for outdoor use. As an example, a properly encased 5 kW generator specified for indoor use at 3600 RPM may be used. The generator 105 may also be sized in kW or kVA as needed for the application. The RPM may be 3600 RPM, 1800 RPM, or any other suitable RPM for continuous output of, for example, 240 volts, 60 Hertz (Hz) at no less than 125% of the rated load. The rated load is the pump motor, or pump motor and accessories, if applicable.

FIG. 12 illustrates the flow control manifold 1200 of FIGS. 11a-11b as an example of installation into a plumbing application, according to an embodiment. The flow control manifold 1200 is shown having an inline turbine/impeller 1208, a bi-directional flow regulator 1209, a main line 1201, and a bypass line 1202. Plumbing configurations, as known in the art, may not be subjected to standard configurations, and therefore many other installations may be possible. As an example, a plumbing configuration with a pump motor 1203, heater 1219, filter 1220, spa in and pool in lines 1221, and spa return and pool return lines 1222 is shown.

FIG. 13 illustrates a partial top view of the flow control manifold 1300, showing the main line 1301, the inline turbine/impeller 1308 in an open state and pool equipment pipe unions 1307 on each end of the main line 1301, and a portion of the bypass line 1302, according to an embodiment. Again, unions 1307 may be added to each end of the line 1301 for facilitating the removal of the inline turbine/impeller 1308, such as, for example, for service or replacement.

FIGS. 14a-14b illustrate a top view and a side view, respectively, of the inline turbine/impeller 1408 of the main line 1401, according to an embodiment. The top view shown in FIG. 4a shows the turbine/impeller 1408 in an open state, and the side view in FIG. 14b shows the turbine/impeller 1407 having a cutaway showing an example of the inside of the component. As an example, FIG. 14a shows how the turbine/impeller 1408 may rotate with respect to the main line 1401. Any suitable configuration of turbines and impellers may be used with the flow control manifold. Again, the ends of the line 1401 may include unions 1407 for removal or replacement, for example, of the turbine/impeller 1408.

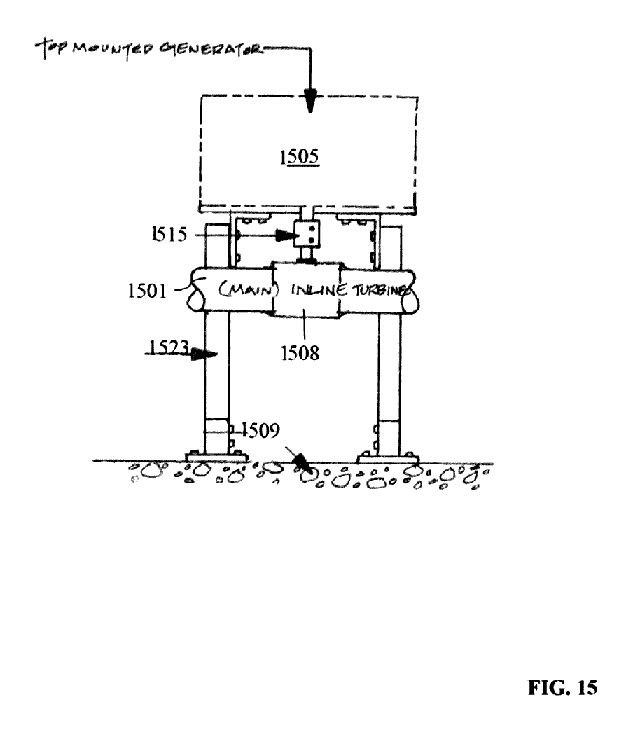

FIG. 15 illustrates a side view of a generator universal mount support 1523 used with the flow control manifold, according to an embodiment. As shown, a top-mounted generator 1505 may be used, for example. As an example, a universal type of mount 1523 having standard, readily available components may be used. The components may, for example, be heavy duty brackets and strut channel floor mounts, for securing the top-mounted generator 1505. As an example, strut channels that are 1 and ⅝ inch by 1 and ⅝ inch in width and length may be used, with any suitable height. Other suitable variations of rigid support may also be used. As another example, a concrete base 1510 may be used for further support. The mount system 1523 may support the bearing weight of the flow control manifold, represented in FIG. 5 by a partial view of the main line 1501 with an inline turbine/impeller 1508. The mount system 1523 preferably does not utilize the plumbing main or bypass lines as a structure support means. The plumbing main line 1501 is preferably self-sustaining within the related plumbing fixtures and fittings. The shaft coupling 1515, coupled between the generator 1505 and the turbine 1508, may additionally aid in supporting the additional weight added by the turbine/impeller 1508 to the independently mounted generator 1505.

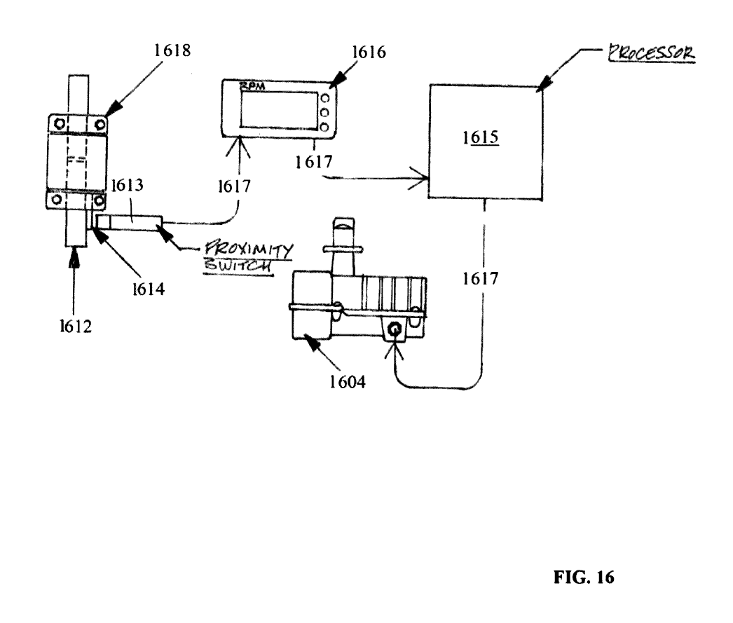

FIG. 16 is a diagram showing the control of the flow control module 1604 using a proximity switch/sensor 1613 as a detection device, according to an embodiment. As an example, the assembly shown in FIG. 16 may be used to control the water flow control module 1604, using a proximity switch/sensor 1613 as a detection device at the shaft 1612. The keyway 1614 installed on the shaft 1612 and shaft coupling 1618 may provide a proximity switch/sensor 1613 pulse for each revolution to the programmable RPM display 1616. The display 1616 may feature an input signal terminal, which may be analog or digital, and may also feature an output in analog or digital output signals to a processor 1615 by, for example, a cable 1617 or any other suitable means. As an example, the processor 1615 may be a Programmable Logic Controller (PLC), Relay Logic, which may include multi-function time delay on/time delay off timing relays. As another example, the processor 1615 may be a custom manufactured programmed microprocessor using proprietary software in the case of the PLC and the microprocessor. The processor input may pulse a 24 volt AC output to the flow control module 1604 for regulating flow to the turbine/impeller unit coupled with the generator by, for example, a cable 1617 or any other suitable means. The components may vary, as any suitable components may be used.

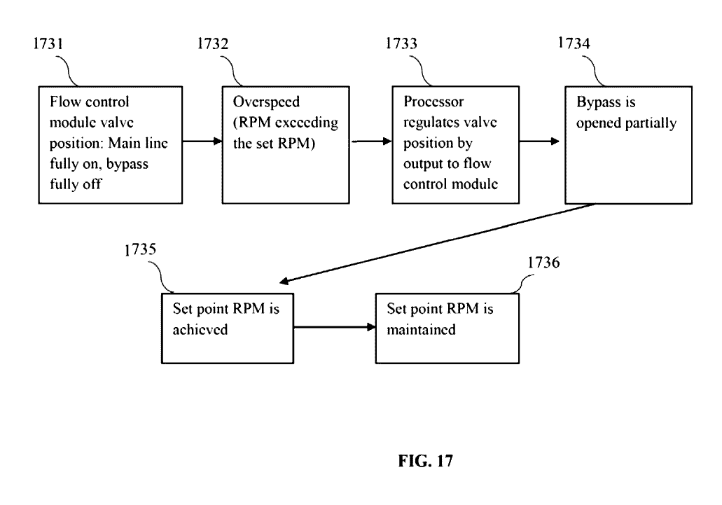

FIG. 17 is a flow chart illustrating a simplified example of a process for regulating the bi-directional valve (1109 in FIG. 11a) for generator speed regulation, according to an embodiment. The bi-directional flow regulator 1109, which may be a valve 1109, may be in the fully closed position with respect to the bypass line (step 1731). An overspeed condition may occur, wherein the RPM of the turbine exceeds the set RPM (step 1732). The processor may regulate the valve position by, for example, output signals to the flow control module (step 1733). The bi-directional flow regulator may open partially with respect to both the main line and the bypass line (step 1734). The bypass line may then be used to bleed off excess water flow from the main line, which may cut down the water flow to the turbine, which may be integrated with the main line. This may regulate the speed of the turbine, which may allow for the RPM that is required by the generator to be maintained. Other alternative approaches may utilize any other suitable methods for generator speed regulation.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. A system comprising a motor coupled to and powering a pump for pumping a liquid, the motor being configured to start by receiving electric power from a power source, a turbine mounted in line with the pump within a conduit where flow of the liquid causes rotation of the turbine, the turbine being associated with a generator, and, an automatic transfer switch configured to monitor a power output of the generator and, when the power output is sufficient for the motor to run, to provide the power output to the motor and to disconnect the power source from the motor.

2. The system of claim 1 wherein the liquid is swimming pool water and the power source is a utility line.

3. The system of claim 2 wherein the automatic transfer switch comprises an electronic time delay initiated by an input indicating that the power output of the generator is sufficient, the electronic time delay allowing the generator to stabilize.

4. The system of claim 3 wherein the electronic time delay is about 20-30 seconds.

5. The system of claim 2 further comprising a flow control manifold configured to regulate the flow of the water through the conduit and thus the speed of the turbine and of the generator.

6. The system of claim 5 wherein the flow control manifold comprises a bypass line and a flow control module having a bi-directional flow regulator configured to divert some of the water through the bypass line, reducing the water flow through the conduit, in order to maintain the speed of the turbine and generator at a predetermined level.

7. The system of claim 6 further comprising a proximity sensor mounted near a shaft of the generator, such that a keyway installed on the shaft provides a proximity sensor's pulse for each revolution of the shaft.

8. The system of claim 7 further comprising a processor configured to receive the proximity sensor's pulses, determine the speed of the shaft of the generator and direct the flow control module on whether to divert some of the water through the bypass line.
